(19) United States
(12) Patent Application Publication
(10) Pub. No.: US 2009/0050023 A1
(43) Pub. Date: Feb. 26, 2009

(54) Method for accelerating the setting and hardening of hydraulic binding agents and mixtures containing the same

(76) Inventors: Christian Buerge, Schafisheim (CH); Harald Bach, Kleinandelfingen (CH)

Correspondence Address: BINGHAM MCCUTCHEN LLP, 2020 K Street, N.W., Intellectual Property Department, WASHINGTON, DC, 20006, US

(21) Appl. No.: 12/285,535

(22) Filed: Oct. 8, 2008

Related U.S. Application Data
(63) Continuation of application No. 10/481,639, filed on Jul. 13, 2004, now abandoned.

(30) Foreign Application Priority Data
Jun. 22, 2001 (EP) 01 114 736.0

(51) Int. Cl. C04B 16/00

(52) U.S. Cl. 106/706; 106/823; 106/708

(57) ABSTRACT

The invention relates to an accelerator used for setting and hardening and a method for accelerating and hardening hydraulic binding agents using said accelerator. The principal components of said accelerator are nitrates, aminoalcohols, hydroxycarboxylic acids and polyalcohols. The hardening acceleration is not connected with a rapid loss in processability, which is common in other accelerated systems.

### CROSS-REFERENCE TO RELATED APPLICATIONS

This application claims the priority of the European patent application no. 01 114 736.0 that was filed on Jun. 22, 2001, and the entire disclosure contained therein is herewith included in the present by way of reference.

### BACKGROUND

1. Field of the Invention

The subject-matter of the present invention comprises an admixture and a method for accelerating the setting and hardening of hydraulic binding agents, in particular for the manufacture of prefabricated elements and the acceleration of the hardening process of concrete produced at the job site; especially preferred is that of self-compacting concrete (SCC).

2. Description of the Related Art

Many substances are already known in the art that accelerate the setting and hardening of concrete. The most commonly used substances include nitrates, formates, thiocyanates, nitrites, mono-, di- and triethanolamine, strongly alkaline reacting substances such as alkali hydroxides, alkali carbonates, alkali silicates, alkali aluminates and alkali earth chlorides.

The strongly alkaline reacting substances cause undesired annoyances for the workers handling them.

Viewed in terms of concrete technology, strongly alkaline setting accelerators reduce the final strength and enlarge shrinkage which may lead to the formation of tears, thereby compromising the durability of the structure.

Chloride-containing setting accelerators are generally undesired at job sites because they may cause corrosion of both the reinforcement steel bars in the concrete as well as the construction equipment.

It is furthermore known that chloride-containing setting accelerators massively reduce the stability of the chemicals, primarily the sulfate stability of the cement as well as long-term strength.

Nitrates have been known in the art for a long time as antifreeze agents, i.e., they effect a setting acceleration at low temperatures. At room temperatures, however, the effectiveness of nitrates is insignificant (refer, e.g., U.S. Pat. No. 4,337,094 (Tokan)).

Calcium formate has already been described as a hardening accelerator for Portland cement in DE 2 611 419; but its effectiveness is considerably below that of CaCl₂. In addition, its solubility in water is too poor.

Ca(NO₂)₂ (refer to SU 563 392) is a very good setting accelerator; however, using it at the necessary concentrations in Europe is inconceivable because it is highly toxic.

The combination of a thiocyanate and an alkanolamine increases, as U.S. Pat. No. 4,373,956 (Rosskopf) teaches, both the hardening speed and the compressive strength of cement-containing products.

Various organic setting accelerators have been described, but only a few are important in the marketplace. Correspondingly, mono-, di- and triethanolamine in combination with nitrates have an accelerating effect with regard to the setting of concrete at low temperatures.

A combination of triethanolamine together with aluminum sulfate increases, in accordance with U.S. Pat. No. 3,782,991 (Bürge), the early strength of construction materials.

The suitability of α-hydroxycarboxyl compounds as a setting accelerator for Portland cement is disclosed in U.S. Pat. No. 4,264,367 (Schutz).

U.S. Pat. No. 4,473,405 (Gerber) describes an accelerator comprised of a nitrate, an alkanolamine and a thiocyanate; combinations of alkanolamine, nitrate, thiocyanate and carboxylic acids are disclosed in EP 0 670 292.

The corrosion-inhibiting effectiveness of alkanolamines with regard to steel is known, e.g., from U.S. Pat. No. 4,726,914.

All of the customarily used accelerators and/or the accelerators described above have one or several disadvantages: they are only active at low temperatures but not at room temperature, they increase the early strength but reduce the final strength in comparison to a corresponding sample not containing the admixture, they abbreviate the time the concrete can be worked with, or they are toxic or corrosive.

EP 0 554 046 A1 describes the use of low-molecular glycols in conjunction with calcium nitrate and calcium nitrite as setting accelerators. But EP 0 554 046 A1 does not give any indications as to the corresponding effectiveness as a hardening accelerator, i.e., as to an accelerated hardening process.

The object of the present invention consisted therefore in providing a setting and hardening accelerator that will supply, primarily in combination with superplasticizers, high early and final strengths of hydraulic binding agents or of mixtures containing hydraulic binding agents, in particular of concrete and mortar, without shortening the processing time that the product can be work with.

### SUMMARY

Surprisingly, it has been found that it is possible using a combination of four components which are specifically:

(1) at least one inorganic nitrate, in particular at last one alkaline and/or alkaline earth and/or aluminum nitrate,

(2) at least one alkanolamine,

(3) at least one carboxylic acid, in particular at least one C1-C6 hydroxycarboxylic acid, and

(4) at least one polyol, in particular at least one C2-C6 polyol to produce accelerators meeting the above referenced requirements.

Further technical advantages of the accelerators according to the invention are the absence of chloride and nitrite as well as the fact that the mixtures have no corrosive effect relative to steel rebars, not least of all thanks to the admixture of an alkanolamine.

The accelerator according to the invention, which is also called an admixture, is especially suitable for accelerating the setting and the hardening of hydraulic binding agents, in particular for the manufacture of prefabricated elements, and for accelerating the hardening process of concrete produced at the job site; especially preferred in this context is self-compacting concrete (SCC). In the first instance, it is possible to shorten the usual hardening acceleration by way of heat (electric or oil heater without steam) or even eliminate it altogether. In the second instance, it is possible to shorten the timeframe for dismantling the formwork for concrete, or it is possible to continue with the concrete placement even at low temperatures. Applications also result from the manufacture of quickly setting cement and mortar mixtures especially for fixing prefabricated parts or for pouring molded parts.

One subject-matter of the present invention is therefore a setting and hardening accelerator for hydraulic binding agents comprised of or containing an accelerating composition that is comprised of the following components and/or of the acid/base reaction products of these components:

(1) at least one inorganic nitrate,

(2) at least one alkanolamine,

(3) at least one carboxylic acid and

(4) at least one polyol.

A further subject-matter of the present invention is a method for accelerating the setting and hardening of a hydraulic binding agent such as cement; in its pure form or as an admixture with latent hydraulic binding agents, usually by adding 0.2 to 5.0 weight % of the accelerator according to the invention relative to the weight of the binding agent. The accelerator according to the invention can be applied as a powder, dispersed or dissolved in water and/or in combination with one or several other concrete admixtures, such as water-reducing admixtures, superplasticizers, liquefiers, silica slurries and/or dispersing agents.

### DETAILED DESCRIPTION OF THE EMBODIMENTS

The setting and hardening accelerators for hydraulic binding agents according to the invention are comprised of or contain at least one inorganic nitrate, which is preferably an alkaline, alkaline earth or aluminum nitrate or mixtures thereof.

A preferred alkanolamine component is comprised of propanolamines and/or ethanolamines, in particular mono-, di- or trialkanolamines as well as alkylalkanolamines, preferably alkylalkanolamines with C1-C3-alkylene. Examples of preferred alkanolamines are monoethanolamine, diethanolamine, triethanolamine, N-methyl-diethanolamine, triisopropanolamine and mixtures thereof.

A preferred carboxylic acid component is comprised of carboxylic acids selected from the group of unsubstituted carboxylic acids, in particular C1-C6 carboxylic acids, α-hydroxycarboxylic acids, polyhydroxycarboxylic acids, α-aminocarboxylic acids and mixtures thereof. Especially preferred are α-hydroxycarboxylic acids, polyhydroxycarboxylic acids and α-aminocarboxylic acids with 1 to 6 C-atoms, as well as, if necessary, aryl-substituted C1-C6 α-hydroxymonocarboxylic acids. Examples of suitable and preferred acids are α-hydroxymonocarboxylic acids, such as lactic acid and an amygdalic acid.

In another preferred embodied example the alkanolamine is used as a salt of an organic carboxylic acid; and preferably the carboxylic acid is one of the above referred to carboxylic acids.

Usable for the manufacture of the accelerator are an alkanolamine as a salt of an acid or an alkanolamine as a salt of different acids or different alkanolamines as a salt of the same acid or different alkanolamines as salts of different acids.

The one polyol is preferably a C2-C6 polyol. 1,2,3-propanetriol is an especially preferred polyol.

The accelerator usually contains the nitrate component in quantities of 10-58 weight %, the alkanolamine component in quantities of 1-20 weight %, the carboxylic acid component in quantities of 1-15 weight % and the polyol component in quantities of 0-20 weight %. Preferably, the accelerator contains the nitrate component in quantities of 15-50 weight %, the alkanolamine component in quantities of 5-20 weight %, the carboxylic acid component in quantities of 2-12 weight % and the polyol component in quantities of 2-15 weight %.

The accelerator is customarily added to the hydraulic binding agent, in particular cement, in the quantity of 0.2-5.0 weight % relative to the weight of the hydraulic binding agent, preferably in the quantity of 0.2-3.5 weight %.

A further subject-matter of the present invention relates to a method for accelerating the setting and hardening of a hydraulic binding agent, such as cement, in its pure form or as a mixture with latent hydraulic binding agents such as fly ash, blast furnace slag, pozzolans, burnt oil shale ash or silica fume as well as mortar and concrete manufactured from the former by adding 0.2 to 5.0 weight % of the accelerator according to the invention relative to the weight of the binding agent.

The accelerators according to the invention can be used in the form of a powder, dispersed or dissolved in water and/or in combination with one or several other concrete admixtures, such as water-reducing admixtures, superplasticizers, liquefiers, silica slurries and/or dispersing agents.

Admixing occurs usually in solid or liquid form directly into the mixing water and to the cement, to the dry mixture or to the finished concrete or mortar mixture.

But a setting or hardening accelerator in powered form can also be applied as a premix in hydraulic binding agents or in dry mortar and concrete; for example, it can be added in with the binding agent at the time of the manufacture of the binding agent at the factory.

In preferred embodied examples the accelerator is added to the dry or binding agent or to the binding agent mixed with water, to mortar or concrete at the factory, at the job site, in the mixing vat, in the feeding pump or directly into the mixture via a static mixer with a powder dosing device or a liquid dosing device.

The following examples are intended to explain the invention in more detail, however, without being in any way restrictive as to its content.

### EXAMPLES 1 TO 4

Utilizing mortar tests, the influence of the individual components and partial mixtures of the accelerator according to the invention is demonstrated.

The testing mixture for examples 1 to 4 is made up as follows:

| | |
|---|---|
| Portland cement CEM I | 1.000 kg |
| Sand 0-5 mm | 3.000 kg |
| Water | 0.395 kg |
| Polycarboxylate superplasticizer | 0.010 kg |
| Component(s) of the accelerator | 0.015 kg |

### Example 1

Effect of an alkanolamine by itself and in combination with a hydroxycarboxylic acid relative to the 28-day compressive strength.

| Admixture | Compressive Strength 28 Days |
|---|---|
| Blank test (without accelerator) | 45 MPa |
| Alkanolamine | 52 MPa |
| Alkanolamine + hydroxycarboxylic acid | 59 MPa |

### Example 2

Example to explain the influence of two alkanolamines that can be used as part of an accelerator according to the invention.

| Admixture | Compressive Strength 1 Day |
|---|---|
| Blank test (without accelerator) | 24 MPa |
| Diethanolamine + lactic acid | 26 MPa |
| N-methyldiethanolamine + lactic acid | 32 MPa |

### Example 3

Example to represent the effect of a nitrate that can be used as part of the accelerator according to the invention. Test temperature 10° C.

| | Compressive Strength | | |
|---|---|---|---|
| Admixture | | 1 Day | 2 Days |

| | | | |
|---|---|---|---|
| Blank test (without accelerator) | 6.4 | MPa | 21 MPa |
| Calcium nitrate | 9.0 | MPa | 24 MPa |
| Aluminum nitrate | 18.0 | MPa | 30 MPa |

### Example 4

Example to explain the effect of polyol.

| Admixture | Compressive Strength 18 h | |
|---|---|---|
| Blank test (without accelerator) | 4.8 | MPa |
| Alkanolamine + lactic acid | 19.8 | MPa |
| Alkanolamine + lactic acid + propanetriol | 24.2 | MPa |

### EXAMPLES 5 TO 7

The following examples 5 to 7 demonstrate the effect of the individual components in conjunction with a polycarboxylate superplasticizer as well as two accelerators according to the invention relative to the ease of working with them (spreading rate 0-60 minutes after mixing), the setting times and relative to the 20-hour compressive strength.

### Concrete Test Mixture:

| | | |
|---|---|---|
| Portland cement CEM I | 7.500 | kg |
| Rock meal | 1.500 | kg |
| Sand 0-1.2 mm | 9.500 | kg |
| Sand 1.2-4 mm | 8.000 | kg |
| Sand 4-8 mm | 4.500 | kg |
| Gravel 8-16 mm | 9.500 | kg |
| Gravel 16-32 mm | 17.000 | kg |

Test cubes with the dimensions of 12×12×12 cm were produced from these concrete mixtures and used to determine the compressive strength values.

The following accelerators according to the invention were used for the test mixtures:

| Accelerator | 1 | 2 |
|---|---|---|
| Alkanolamine lactate | 12% | 9% |
| Inorganic nitrate | 40% | 47% |
| Propanetriol | 10% | 5% |
| Water | 38% | 39% |

### Example 5

Concrete tests at 15° C.; water/cement ratio 0.41 constant:

| | | | | | | Compres- | | |
|---|---|---|---|---|---|---|---|---|
| | | | Spreading | | | sive | Setting time | |
| | | | Rate | | | Strength | [h] | |
| | Concen- | Dosage | [cm] | | | [MPa] | Begin- | |
| Admixture | tration [%] | [%] | 0′ | 30′ | 60° | 20 h | ning | End |
| Polycarboxylate | 22 | 1.0 | 55 | 55 | 55 | 13.0 | 10.5 | 25.0 |
| Superplasticizer | | | | | | | | |
| Polycarboxylate | 22 | 1.0 | 56 | 52 | 54 | 17.7 | 10 | 25.0 |
| Propanetriol | 100 | 0.04 | | | | | | |
| Polycarboxylate | 22 | 1.0 | 53 | 51 | 53 | 20.4 | 10 | 23.0 |
| Methyldiethanolamine | 100 | 0.03 | | | | | | |
| Polycarboxylate | 22 | 1.0 | 54 | 54 | 56 | 18.0 | 9.9 | 23.3 |
| Aluminumnitrate x9H2O | 100 | 0.14 | | | | | | |
| Polycarboxylate | 22 | 1.0 | | | | | | |
| Accelerator 1 according | 100 | 0.3 | 54 | 45 | 48 | 26.1 | 8.6 | 22.0 |
| to the invention | | | | | | | | |
| Polycarboxylate | 22 | 1.0 | 53 | 45 | 49 | 22.5 | 9.5 | 22.0 |
| Propantriol | 100 | 0.08 | | | | | | |
| Polycarboxylate | 22 | 1.0 | 56 | 52 | 54 | 21.5 | 10 | 23.0 |
| Methyldiethanolamine | 100 | 0.06 | | | | | | |
| Polycarboxylate | 22 | 1.0 | 54 | 54 | 57 | 21.2 | 9.8 | 23.0 |
| Aluminumnitrate x9H2O | 100 | 0.28 | | | | | | |
| Polycarboxylate | 22 | 1.0 | | | | | | |
| Accelerator 1 according | 100 | 0.60 | 45 | 34 | 33 | 28.0 | 7.5 | 18.0 |
| to the invention | | | | | | | | |
| Polycarboxylate | 22 | 1.0 | 53 | 41 | 48 | 23.8 | 9.5 | 23.0 |
| Propanetriol | 100 | 0.11 | | | | | | |
| Polycarboxylate | 22 | 1.0 | 53 | 46 | 48 | 24.9 | 10 | 23.0 |
| Methyldiethanolamine | 100 | 0.10 | | | | | | |
| Polycarboxylate | 22 | 1.0 | 48 | 50 | 50 | 25.2 | 8.9 | 20.4 |
| Aluminumnitrate x9H2O | 100 | 0.42 | | | | | | |
| Polycarboxylate | 22 | 1.0 | | | | | | |
| Accelerator 1 according | 100 | 0.90 | 43 | 31 | 32 | 31.9 | 7.5 | 17.0 |
| to the invention | | | | | | | | |

### Example 6

Concrete tests at 10° C.; water/cement ratio 0.44 constant:

| | | | | | | Compres- | | |
|---|---|---|---|---|---|---|---|---|
| | | | Spreading | | | sive | Setting Time | |
| | | | Rate | | | Strength | [h] | |
| | Concen- | Dosage | [cm] | | | [MPa] | Begin- | |
| Admixture | tration [%] | [%] | 0′ | 30′ | 60′ | 20 h | ning | End |
| Polycarboxylate | 36 | 0.3 | 54 | 49 | 46 | 3.2 | 8 | 30.2 |
| Superplasticizer | | | | | | | | |
| Polycarboxylate | 36 | 0.3 | | | | | | |
| Accelerator 1 according | 100 | 0.42 | 53 | 37 | 35 | 5.7 | 8.6 | 24.6 |
| to the invention | | | | | | | | |
| Polycarboxylate | 36 | 0.3 | | | | | | |
| Accelerator 2 according | 100 | 0.54 | 54 | 39 | 38 | 7.6 | 8.1 | 22.0 |
| to the invention | | | | | | | | |
| Polycarboxylate | 36 | 0.4 | 61 | 58 | 61 | 3.7 | 8.3 | 26.8 |
| Superplasticizer | | | | | | | | |
| Polycarboxylate | 36 | 0.4 | | | | | | |
| Accelerator 1 according | 100 | 0.36 | 62 | 49 | 47 | 7.8 | 8.0 | 21.0 |
| to the invention | | | | | | | | |
| Polycarboxylate | 36 | 0.4 | | | | | | |
| Accelerator 2 according | 100 | 0.5 | 62 | 43 | 44 | 11.2 | 8.0 | 20.0 |
| to the invention | | | | | | | | |
| Polycarboxylate | 36 | 0.5 | 52 | 52 | 51 | 3.7 | 8.4 | 27.0 |
| Superplasticizer | | | | | | | | |
| Polycarboxylate | 36 | 0.6 | | | | | | |
| Accelerator 1 according | 100 | 0.40 | 49 | 47 | 46 | 7.7 | 7.9 | 20.1 |
| tto the invention | | | | | | | | |
| Polycarboxylate | 36 | 0.6 | | | | | | |
| Accelerator 2 according | 100 | 0.68 | 51 | 50 | 45 | 13.2 | 7.2 | 18.3 |
| to the invention | | | | | | | | |

### Example 7

This example demonstrates the difference between an accelerator according to the invention in comparison with a commercially available, calcium-nitrate-based accelerator and calcium chloride. The tests were run at a temperature of 10° C. The concrete was plastified with 1% polycarboxylate superplasticizer.

| | | Water/ | | |
|---|---|---|---|---|
| | | Cement | Compressive Strength | |
| Admixture | G/G | Ratio | 1 Day | 2 Days |
| Blank test (without accelerator) | — | 0.460 | 10.5 MPa | 26.7 MPa |
| Commercially available calcium-nitrate-based | 1.0% | 0.470 | 11.3 MPa | 26.0 MPa |
| accelerator | | | | |
| Calcium chloride 30%-solution | 6.0% | 0.480 | 12.7 MPa | 22.1 MPa |
| Accelerator 1 according to the invention | 1.5% | 0.460 | 30.6 MPa | 35.1 MPa |
| Accelerator 2 according to the invention | 1.5% | 0.460 | 31.3 MPa | 37.8 MPa |

While the present application has described preferred embodiments of the invention, clearly, it should be noted that the invention is not limited to these practical examples and can be realized in other ways within the scope of the following claims.

1. The setting and hardening accelerator for hydraulic binding agents wherein said accelerator consists of an accelerating composition that comprising the following components and/or acid/base reaction products of said components:
(1) at least one inorganic nitrate;
(2) at least one alkanolamine;
(3) at least one carboxylic acid; and
(4) at least one polyol.

2. The setting and hardening accelerator as claimed in claim 1 wherein at least one nitrate is selected from the group comprised of alkaline nitrate, alkaline earth nitrate, aluminum nitrate and mixtures thereof.

3. The setting and hardening accelerator as claimed in claim 1 wherein the at least one alkanolamine is selected from the group comprises of ethanolamines, propanolamines and mixtures thereof.

4. The setting and hardening accelerator as claimed in claim 3 wherein the alkanolamine is selected from the group comprised of monoethanolamine, diethanolamine, triethanolamine, N-methyldiethanolamine, triisopropanolamine and mixtures thereof.

5. The setting and hardening accelerator as claimed in claim 1 wherein the alkanolamine is available as a salt of an organic carboxylic acid is a product thereof.

6. The setting and hardening accelerator as claimed in claim 1 wherein the at least one carboxylic acid is selected from the group comprised of unsubstituted carboxylic acids, α-hydroxycarboxylic acids, polyhydroxycarboxylic acids, α-aminocarboxylic acids or mixtures thereof.

7. The setting and hardening accelerator as claimed in claim 6 wherein the at least one carboxylic acid is selected from the group comprised of unsubstituted C1-C6 carboxylic acids, if necessary, aryl-substituted C1-C6 α-aminocarboxylic acids or mixtures thereof.

8. The setting and hardening accelerator as claimed in claim 1 wherein at least one carboxylic acid is an, if necessary, aryl-substituted α-hydroxymonocarboxylic acid or a mixture of such α-hydroxymonocarboxylic acids, in particular lactic acid and/or amygdalic acid.

9. The setting and hardening accelerator as claimed in claim 1 wherein the at least one polyol is a C2-C6 polyol or a mixture of C2-C6 polyols.

10. The setting and hardening accelerator as claimed in claim 9 wherein the polyol is 1,2,3-propanetriol.

11. The setting and hardening accelerator as claimed in claim 1 wherein the accelerator contains at least one nitrate in quantities of 10-58% by weight the at least one alkanolamine in quantities of 1-20% by weight, the at least one carboxylic acid in quantities of 1-15% by weight and the at least one polyol in quantities of 2-20% by weight.

12. The setting and hardening accelerator as claimed in claim 1 wherein the accelerator is available in the form of a powder, a dispersion in water or as an aqueous solution.

13. The setting and hardening accelerator as claimed in claim 1 wherein said accelerator contains additionally a water-reducing admixture or a superplasticizer.

14. A method for accelerating the setting and hardening of a hydraulic binding agent, such as cement, in its pure form or as a mixture with latent hydraulic binding agents such as fly ash, blast furnace slag, pozzolans, burnt oil shale ash or silica fume as well as mortar and concrete produced therefrom by way of adding an accelerator wherein 0.2 to 5.0% by weight of the accelerator relative to the weight of the binding agent, is added to the mixture that contains the referred to binding agent.

15. The method as claimed in claim 14 wherein the setting and hardening accelerator is applied in powdered form and premixed in the hydraulic binding agent, or it is applied in dry mortar or concrete.

16. The method as claimed in claim 14 wherein the setting and hardening accelerator is mixed in with the binding agent during the manufacture of the binding agent at a factory.

17. The method as claimed in claim 14 wherein the accelerator is added to the dry binding agent or to the binding agent mixed in water, mortar or concrete at a factory or at a job site, inside the mixer, in feeding pump, or via a static mixer directly in the mixture by way of a power dosing device or a liquid dosing device.

18. A mixture comprising binding agents, where the mixture contains a hydraulic binding agent and an accelerator, and wherein the accelerator is comprises the following components and/or acid/ base reaction products of said components:
(1) at least one inorganic nitrate;
(2) at least one alkanolamine;
(3) at least one carboxylic acid; and
(4) at least one polyol.

19. The method as claimed in claim 14, wherein the accelerator is comprises the following components and/or acid/ base reaction products of said components:
(1) at least one inorganic nitrate;
(2) at least one alkanolamine;
(3) at least one carboxylic acid; and
(4) at least one polyol.
